(19) United States
(12) Patent Application Publication
(10) Pub. No.: US 2010/0096471 A1
(43) Pub. Date: Apr. 22, 2010

(54) SYSTEM AND METHOD FOR REPELLING BIRDS

(76) Inventor: Momcilo Djordjic, Largo, FL (US)

Correspondence Address: LARSON AND LARSON, 11199 69TH STREET NORTH, LARGO, FL, 33773, US

(21) Appl. No.: 12/252,878

(22) Filed: Oct. 16, 2008

(51) Int. Cl. A01M 7/00

(52) U.S. Cl. 239/67

(57) ABSTRACT

An application for a bird repellent system includes a source of pressurized air, a source of bird repellent fluid and a precision pump. The precision pump sends a metered amount of the bird repellent fluid into a holding tube, and then the pressurized air is routed through the holding tube, forcing the repellent fluid through a connected nozzle at high velocities.

### FIELD OF THE INVENTION

This invention relates to the field of repelling birds and more particularly to a system for a controlled spray of a bird repellent solution to repel birds.

### BACKGROUND

Although birds are a beautiful and very necessary part of nature, there are many situations where their presence is undesirable due to health, safety and cleanliness reasons. For example, birds often cause problems in power grids, airports and even homes. Likewise, birds often feed on farm fields such as sunflower farms. Another problem occurs with billboards, which become a favorite perch for birds. Droppings from birds perching on billboards detract from the billboard and can lead to diseases, especially in those who maintain the billboards.

More particularly, birds often find ways to enter buildings and take advantage of the protection such buildings offer. Birds often enjoy large, high-ceiling buildings such as airplane hangers, warehouses and stores such as hardware stores that have high ceilings. Although the birds are usually harmless to people, they cause a mess from fecal matter, twigs, egg shells, etc., dropped from their nest.

Several attempts have been made to reduce bird problems, many designed primarily for outdoor use. One example is the use of ultrasonic sound. It is not clear if high-frequency sound noise actually repels birds and, in contained areas such as warehouses and hangers, may only confuse birds that are already within these areas.

Another way to repel birds is to apply a material to an area of a building such as the rafters, etc. U.S. Pat. No. 4,693,889 to Chirchirillo describes such a material that is applied to surfaces with, for example, a caulking gun. It is often difficult to cover surfaces at near-roof level.

Another way to repel birds is to fog an area with a mist of a material that is not liked by the target bird such as Methyl Anthranilate. One company (Rejex-it) offers fog dispensers, either hand-held or mounted with a timed-release of fog. The fog solution has been shown to deter birds, but is not practical for use within buildings where the fog will come into contact with people and will fall on floors, products, machinery, etc. Such fog machines have a very limited application radius and must be relocated often.

Another solution is described in U.S. Pat. No. 7,334,745 to Crawford. In this, a device is described with a reservoir for holding a repellent, a venturi for converting the repellent into a mist and a fan for distributing the repellent. This device has several weaknesses. First, the range of operation is limited due to the distance at which the fan can blow the mist. Second, the device is heavy and must be supported on a surface such as the floor. The birds are often present near the ceiling.

What is needed is a device that will provide a directed spray of bird repellent at ceiling levels.

### SUMMARY OF THE INVENTION

A bird repellent system includes a source of pressurized air, a source of bird repellent fluid and a precision pump. The precision pump sends a metered amount of the bird repellent fluid into a holding tube then the pressurized air is routed through the holding tube, forcing the repellent fluid through a connected nozzle at high velocities.

In one embodiment, a system for repelling birds is disclosed including a base unit having an air compressor, a reservoir containing a bird repellent fluid, a precision pump and a controller. The precision pump is connected to the controller and operation of the precision pump is controlled by the controller. A spray head is coupled to the base unit and supported by a mast. The spray head has an air solenoid in fluid communication with the air compressor and a holding tube in fluid communication with the air solenoid. The precision pump is in fluid communication with the air solenoid and in fluid communication with at least one nozzle and the air solenoid is connected to the controller. The precision pump delivers a metered amount of the bird repellent fluid from the reservoir to the holding tube responsive to the controller and the metered amount of the bird repellent fluid is forced from the holding tube out through the at least one nozzle responsive to activation of the air solenoid by the controller.

In another embodiment, a method of repelling birds is disclosed including providing a system for repelling birds that has a base unit having a device for generating high-pressure air, a reservoir for containing a bird repellent fluid, a device for pumping a metered amount of the bird repellent fluid and a device for controlling operation of the system. A spray head is coupled to the base unit, supported by a mast. The spray head has a device for selectively coupling the high-pressure air into a holding tube within the spray head. The holding tube is in fluid communication with the device for pumping and in fluid communication with at least one nozzle. The means for selectively coupling is connected to the device for controlling. The method begins with the controller energizing the precision pump. Responsive to the controller energizing the precision pump, the precision pump delivers a metered amount of the bird repellent fluid to the holding tube. Next, the controller de-energizes the precision pump and energizes the air solenoid. Responsive to the controller energizing the air solenoid, the high-pressure air forces the metered amount of the bird repellent fluid from the holding tube through the at least one nozzle. The controller then de-energizes the air solenoid.

In another embodiment, a system for repelling birds is disclosed including a base unit having a device for generating high-pressure air, a reservoir for containing a bird repellent fluid, a device for pumping a metered amount of the bird repellent fluid and a device for controlling operation of the system. A spray head is coupled to the base unit, supported by a mast. The spray head has a device for selectively coupling the high-pressure air into a holding tube within the spray head. The holding tube is in fluid communication with the device for pumping and in fluid communication with at least one nozzle. The means for selectively coupling is connected to the device for controlling. The device for pumping is adapted to deliver a metered amount of the bird repellent fluid from the reservoir to the holding tube responsive to a control from the device for controlling and the metered amount of the bird repellent fluid is forced from the holding tube out through the at least one nozzle responsive to activation of the device for selectively coupling.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a system for repelling birds of the present invention.

FIG. 2 illustrates a perspective view of a base unit of the present invention.

FIG. 3 illustrates a perspective view of a spray head of the present invention.

FIG. 4 illustrates a plan view of the system for repelling birds of the present invention in use.

FIG. 5 illustrates a schematic view of the system for repelling birds of the present invention.

FIG. 6 illustrates a schematic view of the precision pump of the present invention.

FIG. 7 illustrates a schematic diagram of an exemplary controller of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

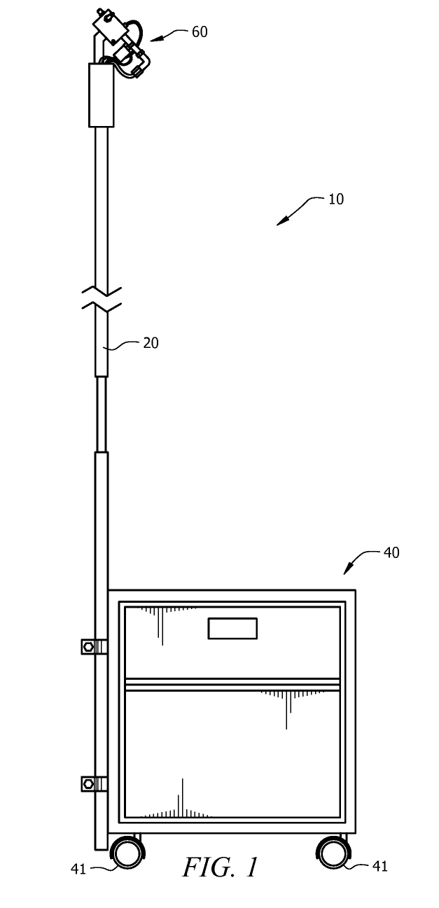

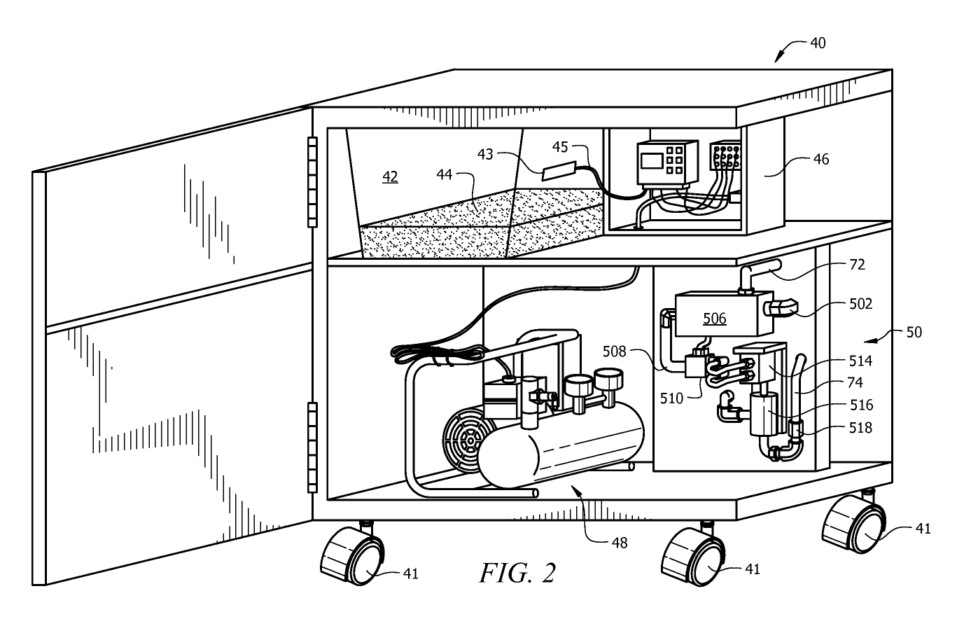

Referring to FIG. 1, a plan view of a system for repelling birds 10 of the present invention is shown. The system for repelling birds 10 comprises a base unit 40, a telescoping mast 20 and a spray head 60. The base unit houses various components (see FIG. 2) and provides weight to the system for repelling birds 10 to provide a balanced support for the telescoping mast 20 and the spray head 60. In some embodiments, the base unit 40 is supported by wheels 41 as known in the industry. The wheels 41 enable relocation of the system for repelling birds 10 to, for example, different locations within a building. The telescoping mast 20 enables the spray head 60 to be located at different heights to reach areas where birds are present. It is anticipated that, in some embodiments, the mast 20 is a fixed height mast 20 and does not telescope.

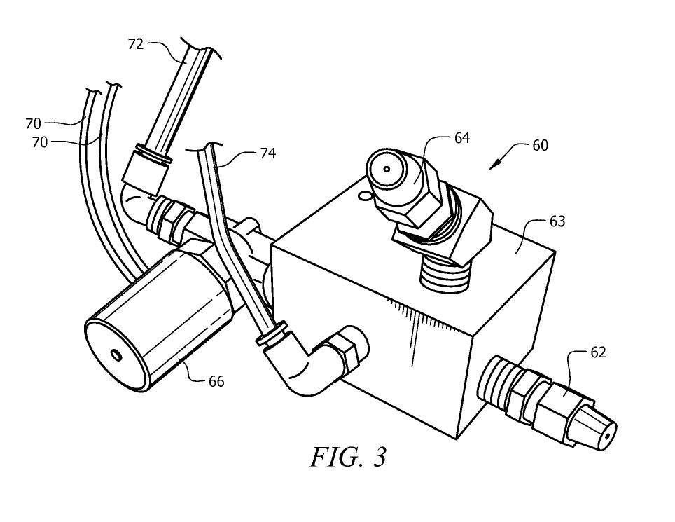

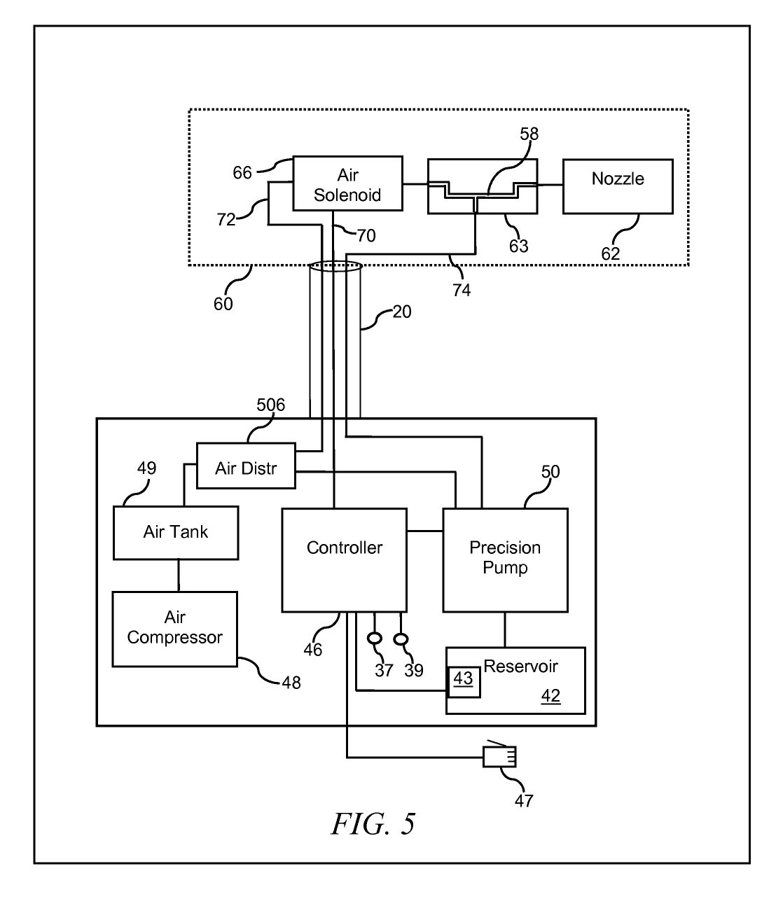

Referring to FIG. 2, a perspective view of a base unit 40 of the present invention is shown. The base unit includes a reservoir 42 containing the bird repellent fluid 44, an air compressor 48, a precision fluid pump 50 and a controller 46. The precision fluid pump 50 pumps the bird repellent fluid 44 from the reservoir 42 through a repellent tube 74 in the mast 20 to a mixing orifice 58 within spray head manifold 63 (see FIG. 5). The air compressor 48 provides high-pressure air to an air solenoid 66 (see FIGS. 3 and 5) through an air delivery tube 72 within the mast 20. The controller 46 provides electrical signals to control the amount and rate of fluid from the precision pump 50. The controller 46 also controls the operation of the air solenoid 66 through wires 70 that also travel within the mast 20.

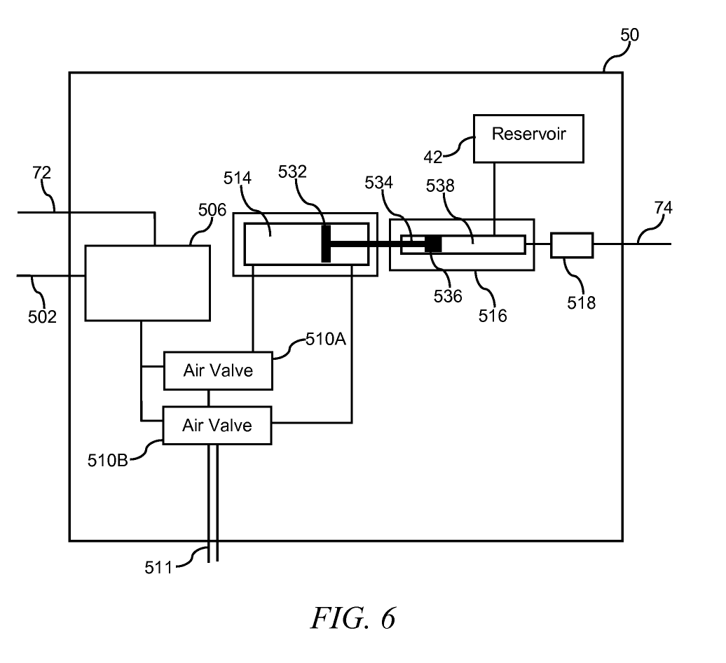

The precision pump 50 includes a compressed air distribution device 506 (e.g., a manifold or coupling), air valves 510, an air cylinder 514, a fluid cylinder 516 and a check valve 518. Compressed air travels from the compressor 48 through a tube/pipe 72 into the distribution device 506. Compressed air travels from the distribution device 506 to the spray head 60 through the air delivery tube 72 and to the air valves 510 through an air tube/pipe 508. Operation of these components is described with FIG. 6.

Referring to FIG. 3, a perspective view of an exemplary spray head 60 of the present invention is shown. The spray head 60 is mounted to the telescoping mast 20 as known in the industry (not visible in FIG. 3). The spray head 60 comprises a spray head manifold 63 with one or more nozzles 62/64 for providing a high-pressure/high-velocity spray of the bird repellent fluid 44. The bird repellent fluid 44 is supplied into the spray head manifold 63 by the repellent tube 74 from the precision pump 50. High pressure air supplied from the compressor 48 is supplied to an input of a solenoid valve 66 through an air delivery tube 72 and the output of the solenoid valve 66 is coupled to the spray head manifold 63. The solenoid valve 66 is controlled remotely by the controller 46 through wires 70.

Although it is preferred to locate the air solenoid 66 on the spray head 60, it is anticipated that in other embodiments, the air solenoid is located at a different location between the air compressor and the spray head 60.

Although two nozzles 62/64 are shown, any number of nozzles 62/64 is anticipated including a single nozzle 62. The bird repellent fluid 44 is forced out of the spray head manifold 66 at high velocity by the high-pressure air from the compressor 48, air delivery tube 72 and solenoid 66.

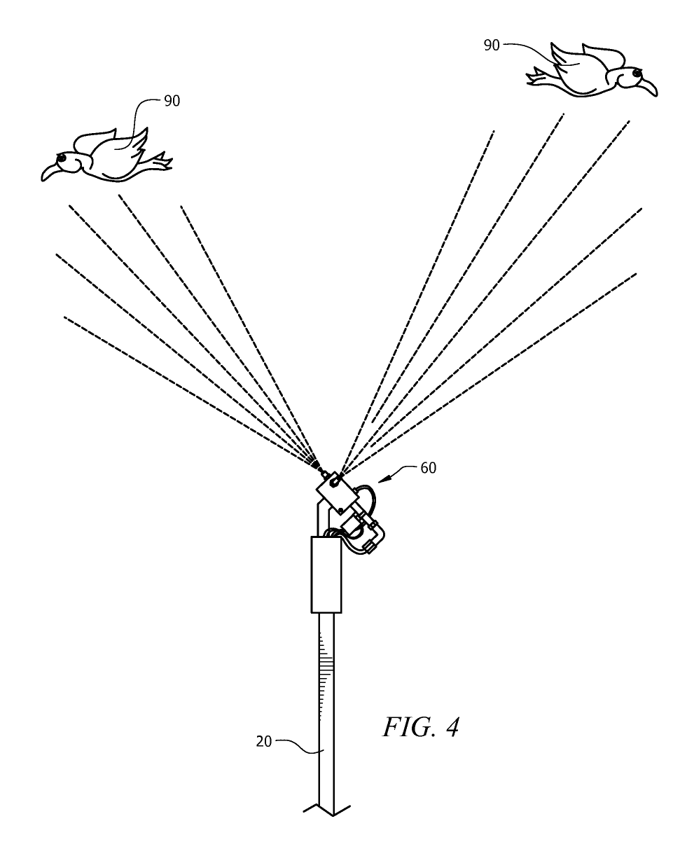

Referring to FIG. 4, a plan view of the system for repelling birds 10 of the present invention is shown in operation. The base unit 40 (not visible in FIG. 4) is positioned to a location in the building in which birds 90 are present. The telescoping mast 20 is adjusted to position the spray head 60 to a height at which the birds 90 are present. The air compressor 48 provides high-pressure air to the solenoid 66 within the spray head 60 and the precision pump 50 is activated by the controller 46 to pump a metered amount of the bird repellent fluid 44 into the spray head manifold 66 and then the controller 46 energizes the air solenoid 66, thereby directing the high-pressure air into the spray head manifold 66 where the high-pressure air forces the bird repellent fluid 44 through the nozzle(s) 62/64 in the direction of the bird 90 activity.

Referring to FIG. 5, a schematic view of the system for repelling birds 10 of the present invention is shown. The controller 46 operates the air solenoid 66 through wires 70. The controller 46 also controls the operation of the precision pump 50 as will be shown in FIG. 6. The preferred operation is for the compressor 48 to operate and fill the air tank 49 with compressed air as known in the industry. The compressed air from the air tank 49 is routed to the air solenoid 66 through, for example, an air distribution block 506 and the air delivery tube/pipe 72. Once sufficient pressure is available in the air tank 49 and, hence, at the input side of the air solenoid 66, the precision pump 50 is energized to pump a specified amount of the bird repellant fluid 44 from the reservoir 42 through the repellent tube 74 and into the holding tube 58 within the spray head manifold 63. Next, the controller energizes the air solenoid 66 through wires 70 and the high-pressure air is forced through the holding tube 58, pushing the specified amount of the bird repellent fluid 44 through the nozzle 62 at a high velocity.

Since the bird repellent fluid 44 is forced through the nozzle 62 at a high velocity, the bird repellent fluid 44 is capable of spreading further than prior application systems. For example, in one application, it was measured that the bird repellent fluid 44 reached 500 feet in each direction, whereas prior technology only reaches tens of feet. This is a sufficient radius from the spray head 60 to cover a 10,000 square foot warehouse with one bird repelling system 10. For larger buildings, several bird repelling systems 10 are anticipated and/or the bird repelling system(s) are moved from location to location within the building on wheels 41. The bird repelling system 10 is also used outdoors to repel birds away from certain crops that are prone to be eaten by birds, for example sun flowers. Similar coverage occurs outdoors.

Although the present invention is anticipated to operate with a wide variety of pumps known in the industry, the precision pump as described is capable of metering and providing the bird repellent fluid 44 in very small granularities, as small as, for example, single drops. Since the bird repellent fluid is a costly part of repelling birds and it is preferred to apply such in liberal amounts, thereby not building up on various surfaces, it is important to control the amount of bird repellent fluid 44 that is dispensed with each burst of high-pressure air. The controller 46 is programmed to deliver the specified amount of the bird repellent fluid 44 to the spray head 60 and then to open the air solenoid 66 for a specified amount of time to force the specified amount of the bird repellent fluid 44 out of the nozzle 62 at high velocities. The controller 46 then closes the air solenoid 66 and schedules its next operation.

In some embodiments, the reservoir 42 has a fluid level sensor 43 connected to the controller 46 by wires 45. The fluid level sensor 43 is any fluid level sensor known in the industry such as float sensors, ultrasonic sensors and the like. The controller 46 monitors the fluid level reading from the fluid level sensor 43. In some embodiments, when the fluid level is down below a certain threshold, the controller 46 illuminates an indicator 39. In some embodiments, when the fluid level is down below a certain threshold, the controller 46 initiates a phone call through, for example, a phone connection 47 (or a cellular call or other wireless means of notifying an operator). In such, a pre-recorded or synthesized message is played when the operator answers the phone call. In some embodiments, a second indicator 37 is provided under control of the controller 46 for indicating proper operation. Other configurations of indicators are anticipated and the present invention is not limited to any particular arrangement of indicators, displays, power switches, controls, etc.

In some embodiments, a pressure sensor (not shown) is connected to the air compressor to detect leaks in the high-pressure air system. In some embodiments, a pressure sensor (not shown) is connected to the output of the precision pump 50 to detect leaks in the fluid system.

Power is provided to the system for repelling birds 10 as known in the industry, including A/C power (e.g., 117 VAC), battery power, rechargeable battery power and solar power. Battery or rechargeable battery power is preferred when the system for repelling birds 10 is relocated on a regular basis. Standard A/C power is preferred when the system for repelling birds 10 is relatively stationary and solar power with an optional rechargeable battery is preferred when the system for repelling birds 10 is used outdoors.

Referring to FIG. 6, a schematic view of the precision pump of the present invention is shown. The precision pump is capable of metering and providing the bird repellent fluid 44 in very small granularities, as small as, for example, single drops. Since the bird repellent fluid 44 is a costly part of repelling birds and it is better if it is applied in liberal amounts, thereby not building up on various surfaces, it is important to control the amount of bird repellent fluid 44 that is dispensed with each burst of high-pressure air. Furthermore, many types of bird repellent fluids 44 degrade upon exposure to moisture in the air and, therefore, the bird repellent system 10 of the present invention mixes the bird repellent fluids with air just before emitting the spray.

Air from the compressor enters through a high-pressure air tube 502 and is distributed to the spray head 60 through the high-pressure air delivery tube 72 and to a pair of air valves 510A/B. The controller 46 controls the air valves 510A/B through a set of wires 511. A first air valve 510A selectively routes air pressure to the left side of an air cylinder 514 and a second air valve 510B selectively routes air to the right side of the air cylinder 514. Therefore, when the controller energizes the first air valve 510A, air pressure pushes an air piston 532 toward the right of the cylinder 514. Likewise, when the controller energizes the second air valve 510B, air pressure pushes the air piston 532 back, toward the left of the cylinder 514. The air piston 532 is coupled to a fluid piston 536 through a shaft 534. When the air piston 532 is pushed by air pressure towards the left, the fluid piston pulls the bird repellent fluid 44 into the fluid cylinder 538 from the reservoir 42 and when the air piston 532 is pushed by air pressure towards the right, the fluid piston pushes the bird repellent fluid 44 from the fluid cylinder 538 through a check valve 518 and through the repellent tube 74 to the spray head 60. Although described in particular details, many other arrangements of similar components are anticipated in different configurations of the precision pump 50.

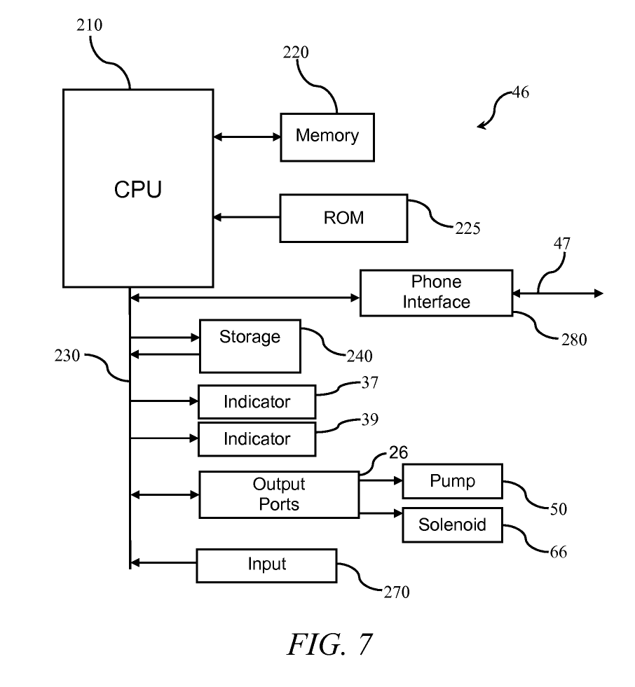

Referring to FIG. 7, a schematic diagram of an exemplary controller 46 of the present invention will be described. Although shown in its simplest form, many different computer architectures are known that accomplish similar results in a similar fashion and the present invention is not limited in any way to any particular computer system. The present invention works well utilizing any processor, controller, programmable interrupt controller, etc., as known in the industry. In the example shown, a processor 210 is provided to execute stored programs that are generally stored for execution within a memory 220. The processor 210 can be any processor or a group of processors, for example an Intel 80C85 or the like. The memory 220 is connected to the processor and can be any memory suitable for connection with the selected processor 210, such as SRAM, DRAM, SDRAM, RDRAM, DDR, DDR-2, etc. Firmware is stored in firmware storage 225 that is connected to the processor 210 and may include initialization software.

Also connected to the processor 210 is a system bus 230 for connecting to peripheral subsystems such as a phone interface 280, storage 240, indicator interfaces 37/39, output ports 260 and inputs 270. The inputs 270 are any control inputs as known in the industry including keyboards, mice, keypads, individual switches, push buttons, etc.

One or more output ports 260 as known in the industry are interfaced to the precision pump 50 and to the air solenoid 66, providing the processor 210 control of the precision pump 50 and to the air solenoid 66

In general, storage 240 may be used to store data and programs. Many storage devices 240 are known such as Flash memory. Other examples of storage include core memory, FRAM, flash memory, etc.

The telephone interface 280 connects the controller 46 to the phone system through a phone cable 47.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for repelling birds, the system comprising:
a base unit, the base unit comprising an air compressor, a reservoir containing a bird repellent fluid, a precision pump and a controller, the precision pump operatively connected to the controller and operation of the precision pump controlled by the controller; and
a spray head coupled to the base unit and supported by a mast, the spray head having an air solenoid in fluid communication with the air compressor, the spray head having a holding tube in fluid communication with the air solenoid, in fluid communication with the precision pump and in fluid communication with at least one nozzle, the air solenoid operatively connected to the controller;
whereas the precision pump is adapted to deliver a metered amount of the bird repellent fluid from the reservoir to the holding tube responsive to the controller and whereas the metered amount of the bird repellent fluid is forced from the holding tube out through the at least one nozzle responsive to activation of the air solenoid by the controller.

2. The system of claim 1, wherein the mast is a telescoping mast.

3. The system of claim 1, further comprising a level sensor operatively coupled to the reservoir, the level sensor signaling to the controller a level of the bird repellent fluid in the reservoir.

4. The system of claim 3, whereas responsive to detecting a low level of bird repellent fluid in the reservoir, the controller initiates a phone call.

5. The system of claim 1, wherein the precision pump comprises:
an air cylinder, an air piston disposed within the air cylinder;
a fluid cylinder, a fluid piston disposed within the fluid cylinder, the fluid cylinder having an input port fluidly coupled to the reservoir and the fluid cylinder having an output port fluidly coupled to a check valve, the check valve allowing the bird repellent fluid to flow in one direction out of the precision pump and into the holding tube within the spray head;
a shaft coupling the air piston to the fluid piston;
a first air valve interfaced between the air compressor and a chamber of the air cylinder distal from the fluid cylinder, the first air valve operatively coupled to the controller; and
a second air valve interfaced between the air compressor and a chamber of the air cylinder closer to the fluid cylinder, the second air valve operatively coupled to the controller;
whereas activation of the first air valve provides compressed air from the air compressor into the chamber of the air cylinder distal from the fluid cylinder, thereby pushing the air piston towards the fluid cylinder and thereby pushing the fluid piston and pushing the bird repellent fluid from the fluid cylinder through the check valve and into the holding chamber, and whereas activation of the second air valve provides compressed air from the air compressor into the chamber of the air cylinder closer to the fluid cylinder, thereby pushing the air piston away from the fluid cylinder and pulling the fluid piston and thereby pulling the bird repellent fluid from the reservoir into the fluid cylinder.

6. The system of claim 1, wherein the compressor includes an air tank.

7. The system of claim 1, wherein the at least one nozzle is one nozzle.

8. The system of claim 1, wherein the base unit is mounted upon a plurality of wheels.

9. A method of repelling birds, the method comprising:
providing a system for repelling birds, the system comprising:
a base unit, the base unit comprising an air compressor, a reservoir containing a bird repellent fluid, a precision pump and a controller, operation of the precision pump controlled by the controller;
a spray head coupled to the base unit and supported by a mast, the spray head having an air solenoid in fluid communication with the air compressor, the spray head having a holding tube in fluid communication with the air solenoid, in fluid communication with the precision pump and in fluid communication with at least one nozzle, the air solenoid operatively connected to the controller;
whereas the precision pump is adapted to deliver a metered amount of the bird repellent fluid from the reservoir to the holding tube responsive to the controller and whereas the metered amount of the bird repellent fluid is forced from the holding tube out through the at least one nozzle responsive to activation of the air solenoid by the controller;
the controller energizing the precision pump;
responsive to the controller energizing the precision pump, the precision pump delivering the metered amount of the bird repellent fluid to the holding tube;
the controller de-energizing the precision pump;
the controller energizing the air solenoid;
responsive to the controller energizing the air solenoid, the high-pressure air forcing the metered amount of the bird repellent fluid from the holding tube through the at least one nozzle; and
the controller de-energizing the air solenoid.

10. The method of claim 9, wherein the mast is a telescoping mast.

11. The method of claim 9, further comprising a level sensor operatively coupled to the reservoir, the level sensor signaling to the controller a level of the bird repellent fluid in the reservoir.

12. The method of claim 11, whereas responsive to detecting a low level of bird repellent fluid in the reservoir, initiating a phone call by the controller.

13. The method of claim 9, wherein the precision pump comprises:
an air cylinder, an air piston disposed within the air cylinder;
a fluid cylinder, a fluid piston disposed within the fluid cylinder, the fluid cylinder having an input port fluidly coupled to the reservoir and the fluid cylinder having an output port fluidly coupled to a check valve, the check valve allowing the bird repellent fluid to flow in one direction out of the precision pump and into the holding tube within the spray head;
a shaft coupling the air piston to the fluid piston;
a first air valve interfaced between the air compressor and a chamber of the air cylinder distal from the fluid cylinder, the first air valve operatively coupled to the controller; and
a second air valve interfaced between the air compressor and a chamber of the air cylinder closer to the fluid cylinder, the second air valve operatively coupled to the controller;
whereas activation of the first air valve provides compressed air from the air compressor into the chamber of the air cylinder distal from the fluid cylinder, thereby pushing the air piston towards the fluid cylinder and thereby pushing the fluid piston and pushing the bird repellent fluid from the fluid cylinder through the check valve and into the holding chamber, and whereas activation of the second air valve provides compressed air from the air compressor into the chamber of the air cylinder closer to the fluid cylinder, thereby pushing the air piston away from the fluid cylinder and pulling the fluid piston and thereby pulling the bird repellent fluid from the reservoir into the fluid cylinder.

14. The method of claim 9, wherein the compressor includes an air tank.

15. The method of claim 9, wherein the at least one nozzle is one nozzle.

16. The method of claim 9, wherein the base unit is mounted upon a plurality of wheels.

17. A system for repelling birds, the system comprising:
a base unit, the base unit comprising a means for generating high-pressure air, a reservoir for containing a bird repellent fluid, a means for pumping a metered amount of the bird repellent fluid and a means for controlling operation of the system; and
a spray head coupled to the base unit and supported by a mast, the spray head having a means for selectively coupling the high-pressure air into a holding tube within the spray head, the holding tube in fluid communication with the means for pumping and the holding tube in fluid communication with at least one nozzle, the means for selectively coupling operatively connected to the means for controlling;
whereas the means for pumping is adapted to deliver a metered amount of the bird repellent fluid from the reservoir to the holding tube responsive to the means for controlling and whereas the metered amount of the bird repellent fluid is forced from the holding tube out through the at least one nozzle responsive to activation of the means for selectively coupling by the means for controlling.

18. The system of claim 17, wherein the means for pumping comprises:
a means for converting the high-pressure air into linear motion under control of the means for controlling; and
a means for converting the linear motion into a fluid pressure.

19. The system of claim 1, wherein the at least one nozzle is one nozzle.

20. The system of claim 1, wherein the base unit is mounted upon a plurality of wheels.
